(19) United States
(12) Patent Application Publication
(10) Pub. No.: US 2026/0286088 A1
(43) Pub. Date: Sep. 24, 2026

(54) ADDITIVES FOR RECYCLING CROSS-LINKED POLYETHYLENE CABLE WASTE

(71) Applicant: NICHEM SOLUTIONS, Thane (IN)

(72) Inventors: Vinod Chintamani MALSHE, Thane (IN); Chinmay PAWAR, Thane (IN)

(21) Appl. No.: 19/469,939

(22) PCT Filed: Feb. 21, 2024
(86) PCT No.: PCT/IN2024/050189

§ 371 Date: Sep. 26, 2025

(30) Foreign Application Priority Data
Apr. 13, 2023 (IN) 202321002713

(51) Int. Cl. C08J 11/26; C08L 23/06

(52) U.S. Cl. CPC C08J 11/26; C08L 23/06; C08J 2323/06; C08L 2205/02; C08L 2207/20

(57) ABSTRACT

The present invention provides additives for recycling of the plastic waste including cross-linked polyethylene cable waste wherein said additives selected from Additive “A” comprising Zinc Stearate; Additive “B” comprising Silica (SiO₂), Aluminium Oxide (Al₂O₃), Titanium Dioxide (TiO₂), Ferric Oxide (Fe₂O₃) and Calcium Oxide (CaO) or Additive “C” comprising additive “A” and additive “B”. The additive depolymerizes plastic waste into a star-shaped low molecular weight polymer for recycling at least 60 to 70% by mixing it with virgin plastic to obtain recycled plastic with enhanced tensile and impact strength. The method for recycling the plastic waste including cross-linked polyethylene cable waste by using the additives of the invention is also disclosed herein.

This application claims priority from Indian Patent Application No. 202321002713 filed on 13 Apr. 2023.

### TECHNICAL FIELD OF THE INVENTION

The present invention relates to the field of recycling of plastic waste.

Particularly, the present invention relates to additives for recycling of plastic waste including cross-linked polyethylene cable waste.

The present invention also relates to a method for the recycling of plastic waste including cross-linked polyethylene cable waste by using the additives of the present invention and converting it into recycled plastic with high strength including tensile and impact strength and reduced elongation at break.

### BACKGROUND OF THE INVENTION

Plastic waste is inevitable and it is increasing every year which need to be destined to the landfills. Land filled plastics stay up to eternity and cause pollution. Serious recycling efforts in plastic will have great impact on reducing carbon emission and slow depletion of fossil resources. Plastic waste comprises polyethylene, polypropylene, polyethylene terephthalate, polystyrene, and PVC but maximum waste comprises polyethylene. Polyethylene is essentially created from the polymerization of ethene (CH2═CH2); therefore, carbon and hydrogen is representing the backbone of its produced waste.

Depending on the branching, crystal structure and the resulting molecular weight, there are several categories of polyethylene, ranging from ultra-high molecular weight to ultra-low molecular weight and high to low density as well as cross-linked polyethylene. Cross-linked polyethylene is a thermosetting plastic and it has enhanced mechanical and/or thermal properties. Important drawback associated with commercial cross-linked plastic is that they are irreversible to cross-linking due to the thermosetting transform. As a result, the cross-linked polyethylene starts degrading or burning instead of melting upon heating. Only when the cross-linked bonds are chemically different from those forming the virgin polymer, reversing the cross-links is possible.

Therefore, recycling thermosets can be achieved by shredding, grinding, and using it as filler. The quantity of the waste as filler need to be tailored so that there are at least no negative or comparable mechanical and thermal properties to that of the virgin polymer. However, the mixing and compounding need to be optimized depending upon the end-user application.

According to our knowledge after conducting the prior art search, the problem of recycling of polyethylene waste including cross-linked polyethylene waste with the overall objective to attain zero waste production was not addressed in any of the existing arts. Therefore, there is a need to develop additives for recycling of plastic waste and a method for the recycling thereof that will address this aforesaid problem.

### Objectives of the Present Invention

The main objective of the present invention is to provide additives for recycling of plastic waste including cross-linked polyethylene cable waste that eliminates the problem of landfilling of the plastic waste as land filled plastics stay up to eternity.

Another objective of the present invention is to provide the additives for recycling of plastic waste including cross-linked polyethylene cable waste wherein the additives degrade the plastic waste into lower molecular weight polymers (masticated plastic) and the same can be recycled at least 30 to 40% by mixing it with virgin plastic to obtain recycled plastic with enhanced tensile and impact strength and reduced elongation at break.

An additional objective of the present invention is to provide a method for the recycling of plastic waste including cross-linked polyethylene cable waste by using the additives of the present invention thereby converting masticated plastic by mixing with virgin plastic to obtain recycled plastic with high strength including tensile and impact strength and reduced elongation at break as compared to virgin plastic.

### SUMMARY OF THE INVENTION

It is surprising to find that the additives of the present invention effectively depolymerize the plastic waste including cross-linked polyethylene cable waste into soft star-shaped low molecular weight polymer which can be easily recycled by mixing it with virgin plastic, particularly polyethylene. It is also surprisingly noted that when this plastic waste is processed according to the invention followed by recycling by mixing it with virgin plastic, particularly polyethylene, it enhanced strength including tensile strength and impact strength and reduced elongation at break.

According to the invention, there is provided additives for recycling of the plastic waste including cross-linked polyethylene cable waste wherein said additive is either Additive “A” comprising Zinc Stearate or Additive “B” comprising Silica (SiO₂), Aluminium Oxide (Al₂O₃), Titanium Dioxide (TiO₂), Ferric Oxide (Fe₂O₃) and Calcium Oxide (CaO) or Additive “C” comprising additive “A” and additive “B”;

said additives depolymerize plastic waste into star shaped low molecular weight polymer for recycling at least 60 to 70% by mixing it with virgin plastic to obtain plastic with enhanced tensile and impact strength and reduced elongation at break.

Typically, the additive “A” of the invention comprises Zinc Stearate.

Typically, the additive “B” of the invention comprises 55 to 60% Silica (SiO₂), 12 to 15% Aluminium Oxide (Al₂O₃), 10 to 12% Titanium Dioxide (TiO₂), 6-8% Ferric Oxide (Fe₂O₃) and 3-5% Calcium Oxide (CaO).
Typically, the additive “C” of the invention comprises the additive “A” and the additive “B” in the ratio of 2:3.

The additive of the invention depolymerizes plastic waste into star-shaped low molecular weight polymer for recycling at least 60 to 70% by mixing it with virgin plastic to obtain plastic with enhanced tensile and impact strength and reduced elongation at break.

According to the invention, there is provided a method for recycling the plastic waste including cross-linked polyethylene cable waste by using the additives of the invention; wherein said method comprises
a) collecting, cleaning and drying the plastic waste followed by shredding the same into pellets;
b) mixing pellets of step (a) with additives of the invention followed by mastication of the mixture in the two roll mill at 180 to 240° C. for 15 to 30 minutes to obtain a masticated plastic;
c) cooling the masticated plastic material and shredding into pellets; and
d) recycling the pellets of step (c) by mixing the same with virgin polyethylene to obtain recycled plastic with enhanced tensile and impact strength and reduced elongation at break.

Typically, the additive is mixed at least 2.5% (by weight) with pellets of step (a).

Typically, the additive is mixed 2.5 to 9% (by weight) with pellets of step (a).

Typically, the mastication is carried out at temperature in the range of 180 to 240° C. for 20 to 30 minutes.

Typically, at least 60% pellets of step (c) are recycled by mixing it with virgin polyethylene.

Typically, 60 to 70% pellets of step (c) are recycled by mixing it with virgin polyethylene.

The crosslinking of polyethylene cable waste is of two types, 1) Peroxide 2) Silane. In the case of peroxide crosslinking, a Carbon-Carbon bond is created between two neighbouring chains while in case of Silane crosslinking, a Silane Carbon binds with Carbon of another chain. The additive of the present invention does not essentially break these bonds but clips off polymer chains randomly. The resultant low molecular weight polymer obtained in the step (c) has a central cross linked core and short chains projecting out like a “star” and thus, “Star shaped polymer” terminology is used to describe the same. This low molecular weight star shaped polymer has a very soft feel due to its star shape projection which is very advantageous feature of the present invention. The resultant low molecular weight star shaped polymer may be categorised as a specialty polymer and may be prepared “on purpose”.

Thus, the problem of recycling of polyethylene waste including cross-linked polyethylene waste with the overall objective to attain zero waste production is achieved by the present invention.

### DETAILED DESCRIPTION OF THE INVENTION

The terms “a,” “an,” “the” and similar referents used in the context of describing the invention following claims are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Certain embodiments of this invention are described herein, including the best mode known to the inventors for carrying out the invention. Of course, variations on these described embodiments will become apparent to those of ordinary skill in the art upon reading the description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the below-described elements in all possible variations thereof is encompassed by the invention unless otherwise indicated herein or otherwise clearly contradicted by context.

In one of the embodiments of the present invention, there is provided additives for recycling of the plastic waste including cross-linked polyethylene cable waste.

The additive of the present invention used for recycling the plastic waste including cross-linked polyethylene cable waste is of three types:
Additive “A” of the present invention comprises of Zinc Stearate;
Additive “B” of the present invention comprises of Silica (SiO₂), Aluminium Oxide (Al₂O₃),
Titanium Dioxide (TiO₂), Ferric Oxide (Fe₂O₃) and Calcium Oxide (CaO); and
Additive “C” of the present invention comprises of the additive “A” and the additive “B”.

Preferably, the additive “B” of the present invention comprises 55 to 60% Silica (SiO₂), 12 to 15% Aluminium Oxide (Al₂O₃), 10 to 12% Titanium Dioxide (TiO₂), 6-8% Ferric Oxide (Fe₂O₃) and 3-5% Calcium Oxide (CaO).

Preferably, the additive “C” of the invention comprises additive “A” and additive “B” in the ratio of 2:3.

The function of the additive is to depolymerize plastic waste into star-shaped low molecular weight polymer which is further recycled by mixing it at least 60 to 70% with virgin plastic to obtain plastic with reduced elongation at break and enhanced tensile and impact strength.

The present invention is demonstrated by using cross-linked polyethylene cable, however, the scope of the present invention should not be restricted to only cross-linked polyethylene cable as plastic waste, but it may be applicable to other plastic wastes including other polyolefin like polypropylene; polystyrene; and PVC; particularly low molecular weight/high molecular weight polymer or low density/high density polymer.

In another embodiment of the present invention, there is provided a method for recycling the plastic waste including cross-linked polyethylene cable waste by using the additives of the invention; wherein said method comprises
a) collecting, cleaning and drying the plastic waste followed by shredding the same into pellets;
b) mixing pellets of step (a) with additives of the invention followed by mastication of the mixture in the two roll mill at 180 to 240° C. for 15 to 30 minutes to obtain a masticated plastic;
c) cooling the masticated plastic material and shredding into pellets; and
d) recycling the pellets of step (c) by mixing the same with virgin polyethylene to obtain recycled plastic with reduced elongation at break and enhanced tensile and impact strength.

The plastic waste is collected mainly from cable manufacturing industries, but it may be collected from various industries or residential areas during renovation or construction or manufacturing stages. The plastic waste is mainly electric cables. These electric cables are segregated according to the colour like yellow, red, green, black, white, blue, etc. These cable wastes are processed to separate out copper from the plastic waste. These plastic wastes are cleaned by thorough washing and drying. The dried cable wastes are shredded into pellets. Typically, the size of the pellets is in the range of 5 to 10 mm. These pellets are used in the present invention for depolymerisation and further recycling.

All three types of additives of the present invention are used in the mastication step (b). In step (b), the function of the additives is to depolymerize plastic waste into star-shaped low molecular weight polymer, particularly having soft touch and melt flow index in the range of 0.1 to 40-45 gm/10 min at 230° C./10 kg load conditions depending on applications.

Mastication is carried out by mixing 2.5 to 9% of the additives of the present invention into the pellets and the mixture is processed in the two roll mill at temperature in the range of 180 to 240° C. for 20 to 30 minutes.

The processing temperature and the processing time is very specific to particular cable waste.

The cables with different degree of cross linking from 85-92% would require different time and temperature ranging from 180-240° C. for 20 to 30 minutes.

Mastication is monitored and controlled by analysing melt flow index at time interval of 15 minutes. Mastication step is stopped when melting flow index (MFI) is reached to desired level of 0.1 to 40-45 gm/10 min.

During mastication of cable waste, particularly cross-linked polyethylene waste is subjected to depolymerisation in the presence of the additive of the invention at specific process parameters and thus converted into low molecular weight polymer, particularly star-shaped polymer. The MFI of the low molecular weight star-shaped polymer upon mastication is 0.1 to 40-45 gm/10 min. The polymer so obtained after mastication has soft touch or feel.

After completion of the mastication, the masticated plastic so obtained is shredded into pellets in step (c) and used further for recyclization of step (d).

There is an attempt to recycle only low molecular weight star-shaped polymer obtained in the mastication step (b) (i.e. masticated plastic) followed by shredding at step (c). This masticated plastic is subjected to recycling by extrusion. But it is observed that it is difficult to mould the masticated plastic into the chips during the moulding due to low MFI (0.1 gm/10 min at 230° C.-10 kg load).

To make the masticated plastic recyclable, 30 to 40% virgin polyethylene is mixed with 70 to 60% pellets of masticated plastic and the mixture is subjected to extrusion.

The addition of virgin polymer to masticated plastic increases the MFI properties of the recycled plastic and makes the recycled plastic mouldable to desired shape suitable for end applications.

The recycling step (d) of the pellets of step (c) by mixing the same with virgin polyethylene to obtain recycled plastic with reduced elongation at break and enhanced tensile and impact strength is carried out by extrusion at 170-260° C. followed by molding at 180-250° C. with 90/100 bar injection pressure/speed, holding pressure/speed 50/60 bar and cooling time 25 seconds.

It is observed that during extrusion, there is difficulty in formation of continuous strands but the same has been eliminated by using die phase cutter type extrusion.

According to the invention, additives “A”, “B” or “C” used for recycling of the plastic waste including cross-linked polyethylene cable waste, the recycled plastic obtained after mixing 30 to 40% virgin polymer in step (d) is tested for mechanical properties like tensile strength (kg/cm²), elongation at break (%) and Izod Impact Strength (KJ/m²).

The recycled plastic obtained in step (d) by using additive “A” has tensile strength in the range of 80.98 to 81.85 kg/cm², elongation at break in the range of 25.88 to 28.75% and Izod Impact Strength in the range of 78.14 to 88.02 KJ/m². When it is compared with virgin polyethylene polymer, it is found that
the recycled plastic obtained in step (d) comprising 70% and 60% masticated plastic increased the tensile strength by 13% and 15% respectively.
the recycled plastic obtained in step (d) comprising 70% and 60% masticated plastic decreased elongation at break by 77% and 80% respectively.
the recycled plastic obtained in step (d) comprising 70% and 60% masticated plastic increased impact strength by 7% and 21% respectively.

The recycled plastic obtained in step (d) by using additive “B” has tensile strength in the range of 85.05 to 87.38 kg/cm², elongation at break in the range of 51.26 to 62.72% and Izod Impact Strength in the range of 79.47 to 82.50 KJ/m². When it is compared with virgin polyethylene polymer, it is found that
the recycled plastic obtained in step (d) comprising 70% and 60% masticated plastic increased the tensile strength by 18% and 23% respectively.
the recycled plastic obtained in step (d) comprising 70% and 60% masticated plastic decreased elongation at break by 49% and 60% respectively.
the recycled plastic obtained in step (d) comprising 70% and 60% masticated plastic increased impact strength by 9% and 14% respectively.

The recycled plastic obtained in step (d) by using additive “C” has tensile strength in the range of 80.47 to 81.23 kg/cm², elongation at break in the range of 73.14% to 75.62% and Izod Impact Strength in the range of 83.98 to 89.18 KJ/m². When it is compared with virgin polyethylene polymer, it is found that
the recycled plastic obtained in step (d) comprising 70% and 60% masticated plastic increased the tensile strength by 14% and 12% respectively.
the recycled plastic obtained in step (d) comprising 70% and 60% masticated plastic decreased elongation at break by 39% and 42% respectively.
the recycled plastic obtained in step (d) comprising 70% and 60% masticated plastic increased impact strength by 23% and 15% respectively.

The resultant recycled plastic comprising masticated plastic of the invention may be used for manufacturing industrial buckets, mugs, profile extruded parts, cables, manhole covers, recycled containers, etc. These are few applications but the scope of the present invention will be restricted to the application which requires tensile strength, elongation at break and impact strength of the recycled plastic of the present invention.

Thus, the problem of recycling of plastic waste including cross-linked polyethylene waste with the overall objective to attain zero waste production is achieved by the present invention. The present invention also eliminates the problem of landfilling of the plastic waste. The additive of the present invention degrades the plastic waste into star-shaped lower molecular weight polymers and the same can be recycled at least 60 to 70% by mixing it with 30 to 40% of virgin plastic resulting into enhanced tensile and impact strength and reduced elongation at break.

The present invention can be illustrated with the below mentioned examples and comparative examples but not by way of limitations. In other words, exemplary illustrations of the operation of the present invention, the practice of its formulation and rendering of the disclosed process are described in the following examples. In addition to the preferred modes of operation, a practitioner of sufficient skill in the art will appreciate that the meets and bounds of the present invention are not limited by the specific instances described herein, rather are defined by the equivalents provided by the claims of the present invention.

### Chemicals Used:

1. XLPE cross-linked polyethylene cable: Procured cable waste from Oman cables;
2. Virgin Polyethylene polymer—M26500 (LLDPE) by Reliance industries;
3. Additive “A”: Zinc stearate supplied by Welcome Chemicals, Thane;
4. Additive “B”: 55 to 60% Silica (SiO₂), 12 to 15% Aluminium Oxide (Al₂O₃), 10 to 12% Titanium Dioxide (TiO₂), 6-8% Ferric Oxide (Fe₂O₃) and 3-5% Calcium Oxide (CaO).
5. Additive “C”: Additive “A” and Additive “B” mixed in the ratio of 2:3.

### Example 1

### Additive “B”

The additive “B” was prepared by mixing the 55 to 60% Silica (SiO₂), 12 to 15% Aluminium Oxide (Al₂O₃), 10 to 12% Titanium Dioxide (TiO₂), 6-8% Ferric Oxide (Fe₂O₃) and 3-5% Calcium Oxide (CaO) together.

### Example 2

### Additive “C”

The additive “C” was prepared by mixing additive “A” and additive “B” in the ratio of 2:3.

### Example 3

### (Recycling of XLPE Cross-Linked Polyethylene Cable Wastes Using Additive “A”)

The cable waste was collected and cables were cleaned by washing. These washed cables were dried and shredded into pellets of 5-10 mm size.

To these pellets, 3% of additive “A” was added and the pellets were further masticated in the two roll mill (Machine type-4×8—2 Roll mill, Sr. No-NCHEM THEN, I/C-008, Manufactured by Indo German Industries-Mumbai) at 210° C. for 30 minutes. Mastication was monitored by analysing the melt flow index at time interval of 15 minutes. Initial melt flow index was found to be 0.004 (ASTM D 1238) and the mastication was stopped when the melt flow index of masticated plastic reached to 40-45 gm/10 min (ASTM D 1238).

The masticated plastic was cooled and shredded into pellets of 3-4 mm size.

60% of masticated pellets were mixed with 40% of virgin polyethylene and the mixture was extruded (Twin screw extruder Alpha 18 by Steer Engineering L/D-44) at 190-235° C. and molded in CN 30 Nigatta Injection molding machine at 200-230° C. with 90/100 bar injection pressure/speed, holding pressure/speed 50/60 bar, cooling time 25 seconds to obtain recycled plastic in the form of dumbbell shaped specimens. These specimens were tested for tensile strength, impact strength and elongation at break. The results are tabulated in Table 1.

### Example 4

### (Recycling of XLPE Cross-Linked Polyethylene Cable Wastes Using Additive “A”)

The masticated pellets were prepared according to Example 3. 70% of masticated pellets were mixed with 30% of virgin polyethylene and the mixture was extruded (Twin screw extruder Alpha 18 by Steer Engineering L/D-44) at 190-235° C. and molded in CN 30 Nigatta Injection molding machine at 200-230° C. with 90/100 bar injection pressure/speed, Holding pressure/speed 50/60 bar, cooling time 25 seconds to obtain recycled plastic in the form of dumbbell shaped specimens. These specimens were tested for tensile strength, impact strength and elongation at break. The results are tabulated in Table 1.

### Example 5

### (Recycling of XLPE Cross-Linked Polyethylene Cable Wastes Using Additive “B”)

The cable waste was collected and cables were cleaned by washing. These washed cables were dried and shredded into pellets of 5-10 mm size.

To these pellets, 3% of additive “B” was added and the pellets were further masticated in the two roll mill (Machine type-4×8—2 Roll mill, Sr. No-NCHEM THNE, I/C-008, Manufactured by Indo German Industries-Mumbai) at 210° C. for 30 minutes. Mastication was monitored by analysing the melt flow index at time interval of 15 minutes. Initial melt flow index was found to be 0.004 (ASTM D 1238) and the mastication was stopped when the melt flow index of masticated plastic reached to 46 gm/10 min (ASTM D 1238).

The masticated plastic was cooled and shredded into pellets of 3-4 mm size. 60% of masticated pellets were mixed with 40% virgin polyethylene and the mixture was extruded (Twin screw extruder Alpha 18 by Steer Engineering L/D-44) at 190-235° C. and molded in CN 30 Nigatta Injection molding machine at 200-230° C. with 90/100 bar injection pressure/speed, Holding pressure/speed 50/60 bar, cooling time 25 seconds to obtain recycled plastic in the form of dumbbell shaped specimens. These specimens were tested for tensile strength, impact strength and elongation at break. The results are tabulated in Table 1.

### Example 6

### (Recycling of XLPE Cross-Linked Polyethylene Cable Wastes Using Additive “B”)

The masticated pellets were prepared according to Example 5. 70% of masticated pellets were mixed with 30% of virgin polyethylene and the mixture was extruded (Twin screw extruder Alpha 18 by Steer Engineering L/D-44) at 190-235° C. and molded in CN 30 Nigatta Injection molding machine at 200-230° C. with 90/100 bar injection pressure/speed, Holding pressure/speed 50/60 bar, cooling time 25 seconds to obtain recycled plastic in the form of dumbbell shaped specimens. These specimens were tested for tensile strength, impact strength and elongation at break. The results are tabulated in Table 1.

### Example 7

### (Recycling of XLPE Cross-Linked Polyethylene Cable Wastes Using Additive “C”)

The cable waste was collected and cables were cleaned by washing. These washed cables were dried and shredded into pellets of 5-10 mm size.

To these pellets, 5% of additive “C” was added and the pellets were further masticated in the two roll mill (Machine type-4×8—2 Roll mill, Sr. No-NCHEM THNE, I/C-008, Manufactured by Indo German Industries-Mumbai) at 210° C. for 30 minutes. Mastication was monitored by analysing the melt flow index at time interval of 15 minutes. Initial melt flow index was found to be 0.004 (ASTM D 1238) and the mastication was stopped when the melt flow index of masticated plastic reached to 46 gm/10 min (ASTM D 1238).

The masticated plastic was cooled and shredded into pellets of 3-4 mm size. 60% of masticated pellets were mixed with 40% virgin polyethylene and the mixture was extruded (Twin screw extruder Alpha 18 by Steer Engineering L/D-44) at 190-235° C. and molded in CN 30 Nigatta Injection molding machine at 200-230° C. with 90/100 bar injection pressure/speed, Holding pressure/speed 50/60 bar, cooling time 25 seconds to obtain recycled plastic in the form of dumbbell shaped specimens. These specimens were tested for tensile strength, impact strength and elongation at break. The results are tabulated in Table 1.

### Example 8

### (Recycling of XLPE Cross-Linked Polyethylene Cable Wastes Using Additive “C”)

The masticated pellets were prepared according to Example 7. 70% of masticated pellets were mixed with 30% of virgin polyethylene and the mixture was extruded (Twin screw extruder Alpha 18 by Steer Engineering L/D-44) at 190-235° C. and molded in CN 30 Nigatta Injection molding machine at 200-230° C. with 90/100 bar injection pressure/speed, Holding pressure/speed 50/60 bar, cooling time 25 seconds to obtain recycled plastic in the form of dumbbell shaped specimens. These specimens were tested for tensile strength, impact strength and elongation at break. The results are tabulated in Table 1.

The virgin polyethylene (control sample) was tested for tensile strength, impact strength and elongation at break for comparative study.

### ASTM D-638 (Tensile Strength Measurement):

### Instrument Details: Twin UTM (Manufacturer: International Equipment)

### Test Conditions:

### Dimension of Specimen: 111.40×13.15×3.04 mm

### Conditioning Period: 24 hrs 25±2° C. & 50±5% RH

Test speed: 50 mm/min

### ASTM D-256 (Izod Impact Strength Measurement)

### Instrument Details: Impact Tester (Manufacturer: Asian Test Equipment)

### Test Conditions:

### Dimension of Specimen: 11.15×2.97 mm (Notched Specimen)

### Conditioning Period: 24 hrs 25±2° C. & 50±5% RH

Weight of pendulum: 1.46 kg
Release angle: 135°±2°

TABLE 1
Mechanical properties of the recycled plastic obtained according to examples 3 to 8

| | | % Increase | | | | |
|---|---|---|---|---|---|---|
| | | in Tensile | | | Izod | % Increase |
| | | Strength | | % Decrease | Impact | in Izod |
| | Tensile | compared | Elongation | in Elongation | Strength | Impact |
| Examples | Strength | to control | at break | at break | (KJ/m2) | Strength |
| Control (virgin | 71.53 | — | 125.33 | — | 72.86 | — |
| polyethylene) | | | | | | |
| Example 3 | 80.98 | 13.12 | 25.88 | 79.35 | 78.14 | 7.24 |
| Example 4 | 81.85 | 14.42 | 28.75 | 77.06 | 88.02 | 20.80 |
| Example 5 | 87.38 | 22.15 | 51.26 | 59.09 | 82.50 | 13.23 |
| Example 6 | 85.05 | 18.90 | 62.72 | 49.95 | 79.47 | 9.07 |
| Example 7 | 80.47 | 12.49 | 73.14 | 41.64 | 83.98 | 15.26 |
| Example 8 | 81.23 | 13.56 | 75.62 | 39.66 | 89.18 | 22.39 |

According to the results as illustrated in the Table 1, the additives “A”, “B” and “C” when added to XLPE cross-linked polyethylene cable wastes and processed as per the examples 3 to 8 followed by recycling at least 60 to 70% masticated plastic by mixing it with 30 to 40% of virgin plastic resulting into enhanced tensile and impact strength and reduced elongation at break of the recycled plastic. The resultant recycled plastic obtained as per the examples 3 to 8 can be used in suitable end applications which requires tensile strength, elongation at break and impact strength of the recycled plastic of the present invention like manufacturing industrial buckets, mugs, profile extruded parts, cables, manhole covers, recycled containers, etc. Thus, the problem of recycling of plastic waste including cross-linked polyethylene waste with the overall objective to attain zero waste production is achieved by the present invention. The present invention also eliminates the problem of land filling of the plastic waste.

1. An additive for recycling of plastic waste including cross-linked polyethylene cable waste, comprising:
Additive “A” comprising Zinc Stearate; Additive “B” comprising Silica (SiO₂), Aluminium Oxide (Al₂O₃), Titanium Dioxide (TiO₂), Ferric Oxide (Fe₂O₃) and Calcium Oxide (CaO); or Additive “C” comprising additive “A” and additive “B”;
wherein said additive depolymerizes plastic waste into a star-shaped low molecular weight polymer for recycling to obtain a recycled plastic with enhanced tensile and impact strength, wherein at least 60 and up to 70% (by total weight of the recycled plastic) star-shaped low molecular weight polymer is mixed with 30 to 40% (by total weight of the recycled plastic) virgin plastic to obtain the recycled plastic.

2. (canceled)

3. The additive of claim 1, wherein the additive “B” comprises 55 to 60% Silica (SiO₂), 12 to 15% Aluminium Oxide (Al₂O₃), 10 to 12% Titanium Dioxide (TiO₂), 6-8% Ferric Oxide (Fe₂O₃) and 3-5% Calcium Oxide (CaO).

4. The additive of claim 1, wherein the additive “C” comprises additive “A” and additive “B” in the ratio of 2:3.

5. A method for recycling plastic waste including cross-linked polyethylene cable waste, comprising:
a) collecting, cleaning and drying the plastic waste followed by shredding the plastic waste into pellets;
b) mixing the pellets of step(a) with the additive of claim 1 to create a mixture followed by mastication of the mixture into a two roll mill to obtain a masticated plastic;
c) cooling the masticated plastic material and shredding into pellets; and
d) recycling the pellets of step (c) by mixing the same with virgin polyethylene to obtain recycled plastic.

6. The method as claimed in claim 5, wherein the pellets of step (a) are mixed with at least 2.5% (by total weight of the mixture of step (b)) additive of the claim 1 in step (b).

7. The method as claimed in claim 6, wherein the pellets of step (a) are mixed with 2.5 to 9% (by total weight of the mixture of step (b)) additive of the claim 1 in step (b).

8. The method as claimed in claim 5, wherein the mastication in step b) is carried out at temperature in the range of 180 to 240° C. for 20 to 30 minutes.

9. The method as claimed in claim 5, wherein at least 60% (by total weight of the recycled plastic of step (d)) pellets of step (c) are recycled by mixing them with virgin polyethylene in step (d).

10. The method as claimed in claim 9, wherein 60 to 70% (by total weight of the recycled plastic of step (d)) pellets of step (c) are recycled by mixing them with virgin polyethylene in step (d).

11. A method for recycling plastic waste including cross-linked polyethylene cable waste, comprising:
a) collecting, cleaning and drying the plastic waste followed by shredding the same into pellets;
b) mixing pellets of step(a) with the additive of claim 3 followed by mastication of the mixture in two roll mill to obtain a masticated plastic;
c) cooling the masticated plastic material and shredding into pellets; and
d) recycling the pellets of step (c) by mixing the same with virgin polyethylene to obtain recycled plastic.

12. The method as claimed in claim 11, wherein the pellets of step (a) are mixed with at least 2.5% (by total weight of the masticated plastic of step (b)) additive of the claim 3 in step (b).

13. The method as claimed in claim 12, wherein the pellets of step (a) are mixed with 2.5 to 9% (by total weight of the masticated plastic of step (b)) additive of the claim 3 in step (b).

14. The method as claimed in claim 11, wherein the mastication in (step (b) is carried out at temperature in the range of 180 to 240° C. for 20 to 30 minutes.

15. The method as claimed in claim 11, wherein 60 to 70% (by total weight of the recycled plastic of step (d)) pellets of step (c) are recycled by mixing them with virgin polyethylene in step (d).

16. A method for recycling plastic waste including cross-linked polyethylene cable waste, comprising:
a) collecting, cleaning and drying the plastic waste followed by shredding the same into pellets;
b) mixing pellets of step(a) with the additive of claim 4 followed by mastication of the mixture in two roll mill to obtain a masticated plastic;
c) cooling the masticated plastic material and shredding into pellets; and
d) recycling the pellets of step (c) by mixing the same with virgin polyethylene to obtain recycled plastic.

17. The method as claimed in claim 16, wherein the pellets of step (a) are mixed with at least 2.5% (by total weight of the masticated plastic of step (b)) additive of the claim 4 in step (b).

18. The method as claimed in claim 17, wherein the pellets of step (a) are mixed with 2.5 to 9% (by total weight of the masticated plastic of step (b)) additive of the claim 4 in step (b).

19. The method as claimed in claim 16, wherein the mastication in step (b) is carried out at temperature in the range of 180 to 240° C. for 20 to 30 minutes.

20. The method as claimed in claim 16, wherein 60 to 70% (by total weight of the recycled plastic of step (d)) pellets of step (c) are recycled by mixing them with virgin polyethylene in step (d).
